(19) United States
(12) Patent Application Publication
(10) Pub. No.: US 2019/0311105 A1
(43) Pub. Date: Oct. 10, 2019

(54) GENERATING AUTHENTICATION ASSERTIONS INCLUDING AN ASSURANCE SCORE

(71) Applicant: Hewlett-Packard Development Company, L.P., Spring, TX (US)

(72) Inventors: Mike Beiter, Fort Collins, CO (US); Natan Facchin, Porto Alegre (BR); Lucas Albuquerque de Almeida, Porto Alegre (BR)

(73) Assignee: Hewlett-Packard Development Company, L.P., Spring, TX (US)

(21) Appl. No.: 16/340,703

(22) PCT Filed: Oct. 18, 2016
(86) PCT No.: PCT/US2016/057502

§ 371 Date: Apr. 10, 2019

(51) Int. Cl. G06F 21/34; G06F 21/32; G06F 21/31

(52) U.S. Cl. CPC G06F 21/34; G06F 2221/2115; G06F 21/316; G06F 21/32

(57) ABSTRACT

One example of a system includes an authentication sever and an authentication consumer. The authentication server is to authenticate a user using an authentication process, collect environment specific attributes about the user during the authentication process, compute an assurance score based on the collected environment specific attributes, and generate an authentication assertion including the assurance score upon a successful user authentication. The authentication consumer is to receive the authentication assertion including the assurance score and make a local entitlement decision based on the assurance score.

### BACKGROUND

To grant an entity (e.g., human, device, or application—also known as “user”) access to a protected resource, the entity typically is identified first. The identification process is known as authentication. The security level of the authentication process, and hence the authentication procedure, depends on the nature of the protected resource. For example, access to a public Internet discussion board requires a different level of identity proof than access to a bank account.

### BRIEF DESCRIPTION OF THE DRAWINGS

FIG. 1A is a block diagram illustrating one example of a system for generating and using authentication assertions including an assurance score based on environment specific attributes.

FIG. 1B is a block diagram illustrating another example of a system for generating and using authentication assertions including an assurance score based on environment specific attributes.

FIG. 2 is a block diagram illustrating one example of a processing system for generating an authentication assertion including an assurance score based on orthogonal factors.

FIG. 3 is a flow diagram illustrating one example of a method for generating and using authentication assertions including an assurance score based on orthogonal factors.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

While authentication processes have typically been perceived as a function providing a binary result (i.e., authentication passed or failed), standard bodies such as the Organization for the Advancement of Structured Information Standards (OASIS) and the Internet Engineering Task Force (IETF) have introduced authentication quality assurance assertions. Such assertions provide an indication of the proof of identity being used during the authentication and are commonly based on the authentication method. The method of identity proof that has been used to authenticate the entity in question (e.g., user, device) is often made available to the authentication consumer as a set of assertions in a token. These assertions then allow the authentication consumer to establish a security context before making an entitlement decision based on the provided authentication evidence.

Common implementations of authentication assertions include “assertions” in Security Assertion Markup Language (SAML) and “claims” in OpenID Connect. These fields either include numeric levels as an easily comparable metric, references to well-known named classes, or a combination thereof. An assertion consumer must generally be familiar with the various classes to interpret them correctly in a specific context.

While the concept of classes for authentication quality is powerful, the currently available assurance levels do not provide any indication on environment specific aspects of the authentication operation. For example, when a user authenticates using a username and password authentication process, the common frameworks like SAML pass this information on to the authentication consumer. The authentication consumer, however, does not have any indication on how the authentication process was exactly performed. For example, did the user enter their password incorrectly a few times before the authentication was successful? Did it take a long time for the user to remember their password? Was the user nervous while they performed the operation?

Authentication is a process that a user performs frequently in the physical world. For example, a user may authenticate to a police officer during a traffic stop. While the officer will frequently rely on government authentication documents as proof of the user's identity (e.g., a passport or a driver's license), the officer will also observe the user's behavior. For example, does the user hesitate to identify themselves? Are they under stress? Can they answer basic questions (e.g., with respect to their residence) without hesitation?

Accordingly, a system and method is described herein to detect environment specific attributes that are orthogonal to the authentication result, and then introduce them into the authentication assertion. These attributes do not introduce a secondary authentication factor that is validated as an additional proof of identity (e.g., as in two factor authentication), but rather represent certain aspects of the environment in which the authentication took place. These additional attributes may be made available to the authentication consumer to allow the authentication consumer to locally make a more fine-grained authorization and/or entitlement decision.

Therefore, a protocol is described to authenticate a user and collect orthogonal factors (e.g., environment specific attributes), compute an authentication assurance score based on the orthogonal factors, and make the assurance score available to the authentication consumer either directly in the proof of authentication or indirectly through a callback operation. This allows the protocol to be implemented as extensions to existing authentication standards such as SAML and OpenID Connect.

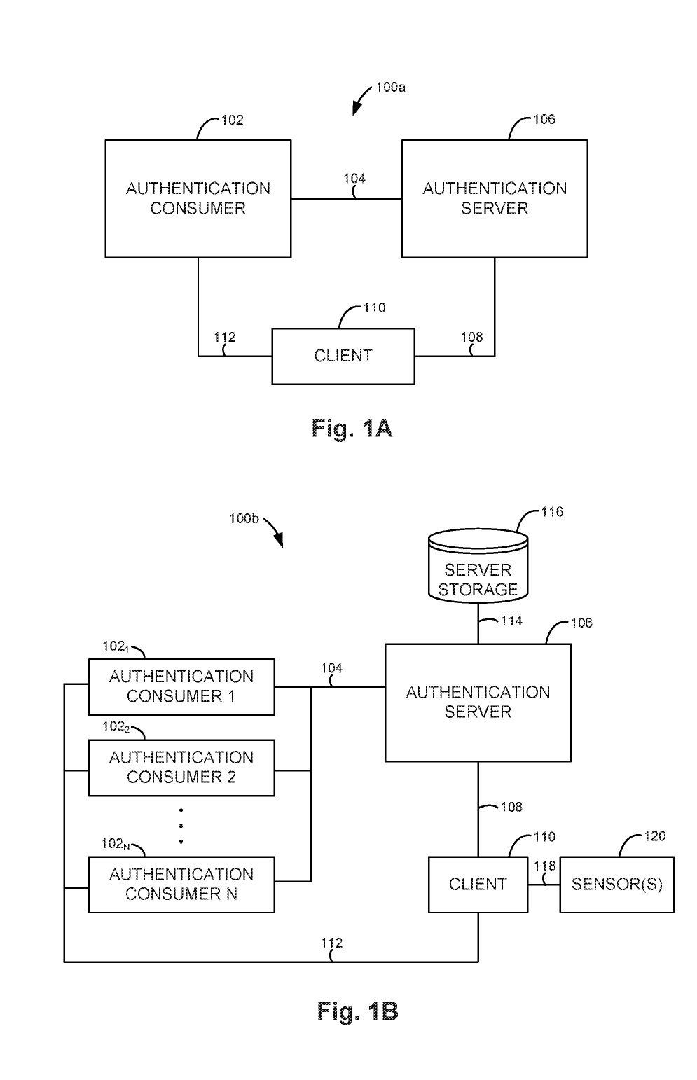

FIG. 1A is a block diagram illustrating one example of a system 100a for generating and using authentication assertions including an assurance score based on environment specific attributes. System 100a includes an authentication consumer 102, an authentication server 106, and a client 110. Authentication consumer 102 is communicatively coupled to authentication server 106 through a communication path 104. Authentication server 106 is communicatively coupled to client 110 through a communication path 108. Client 110 is communicatively coupled to authentication consumer 102 through a communication path 112.

Authentication server 106 implements an authentication process to authenticate a user of client 110. Client 110 may be a user computing device, such as a workstation, a communication station, a computer, a mobile phone, a tablet, or other suitable user device. The authentication process may be any suitable authentication process appropriate for the user's and server's authentication protocol and security needs (e.g., username and password, fingerprint, etc.). During the authentication process, authentication server 106 collects additional factors about the user that are orthogonal to the actual authentication process. Additional orthogonal factors may also be derived from authentication factors.

The orthogonal factors may be detected by various sensors and include, but are not limited to:
(1) Stress patterns in the user's anatomy that indicate fraud or distress, such as:
   a. The user's voice
   b. The user's iris
   c. The user's galvanic skin response and heart rate
(2) Patterns in the user's behavior that are not aligned with previously learned behavior, thus indicating fraud or distress, such as:
   a. Erratic body movement
   b. Rapid eye movement
(3) Metadata derived from available sensors (e.g., camera, microphone) that are not aligned with previously learned behavior, thus indicating potential fraud, such as:
   a. Gender
   b. Age
   c. Certain medical conditions that manifest themselves in specific voice fingerprint patterns
(4) Presence (of lack thereof) of Internet of Things (IoT) enabled body implants such as:
   a. Insulin pumps
   b. Cardiac pacemakers

Authentication server 106 computes an authentication assurance score based on the collected environment specific attributes. This authentication assurance score is different from existing scoring methods that consider the authentication method in so far as the assurance score is based on the orthogonal factors, and not on the authentication process itself. The authentication assurance score may be calculated using any suitable method.

Authentication server 106 generates an authentication assertion (e.g., a proof of authentication) including the assurance score upon a successful user authentication. In one example, authentication server 106 may store the authentication assertion including the assurance score for later retrieval by authentication consumer 102. Authentication consumer 102 may be an application running on a server separate from authentication server 106.

Authentication server 106 returns the proof of authentication to client 110. This proof of authentication may be a self-contained bearer token (e.g., when this protocol is implemented on top of existing solutions such as SAML) or a reference that may be later resolved by authentication consumer 102 (e.g., when this protocol is implemented on top of existing solutions such as certain implementations of OpenID Connect).

Client 110 presents the proof of authentication to authentication consumer 102. Depending upon the implementation, authentication consumer 102 may receive the authentication assertion with the proof of authentication from client 110 or may use the proof of authentication to retrieve the authentication assertion from authentication server 106.

Authentication consumer 102 makes a local entitlement decision based on the assurance score, which provides a non-discrete metric of “contextual trust.” This comparison may be, for example, a numeric comparison of the assurance score to one or more pre-defined thresholds. These thresholds may be freely determined by authentication consumer 102, and may depend on the specific operation requested by client 110. For example, authentication consumer 102 may offer operations that are not very sensitive in nature and thus require a lower level of contextual assurance. In addition, authentication consumer 102 may offer operations that are highly sensitive in nature and thus require a higher level of contextual assurance. The local entitlement decision based on the assurance score may result in rejecting user access to processes of authentication consumer 102, allowing user access to processes of authentication consumer 102, or allowing partial user access to processes (i.e., allowing access to at least one process and rejecting access to at least one other process) of authentication consumer 102.

FIG. 1B is a block diagram illustrating another example of a system 100b for generating and using authentication assertions including an assurance score based on environment specific attributes. System 100b includes a plurality of authentication consumers 102₁ through 102_{N}, where “N” is any suitable number. System 100b also includes authentication server 106, client 110, server storage 116, and at least one sensor 120. Each authentication consumer 102₁ through 102_{N} is communicatively coupled to authentication server 106 through communication path 104. Authentication server 106 is communicatively coupled to client 110 through communication path 108 and to server storage 116 through a communication path 114. Client 110 is communicatively coupled to each authentication consumer 102₁ through 102_{N} through communication path 112 and to sensor(s) 120 through a communication path 118.

Server storage 116 is a non-transitory storage medium and may be any suitable electronic, magnetic, optical, or other physical storage device. Server storage 116 may store authentication assertions including assurance scores computed by authentication server 106 for later retrieval by authentication consumers 102₁ through 102_{N}. Authentication consumers 102₁ through 102_{N} may then retrieve authentication assertions including the assurance scores in response to receiving a request from client 110. In addition, server storage 116 may store patterns used in the computation of assurance scores based on the orthogonal factors. In one example, the stored patterns may include patterns indicating fraud or distress, such as physiological or behavioral patterns. Patterns indicating normal (i.e., not indicating fraud or distress) physiological or behavioral patterns may be learned from a user and stored in server storage 116. The stored normal patterns may then be compared to current physiological or behavioral patterns during an authentication process to determine whether the current physiological or behavioral patterns vary from the stored patterns.

Sensor(s) 120 include at least one sensor to sense physiological or behavioral data of a user to provide the environment specific attributes. Sensor(s) 120 may include a microphone, a camera, a heart rate monitor (e.g., a wearable device such as a fitness tracker), an iris sensor, an IoT device, and/or another suitable sensor for detecting physiological or behavioral information about a user.

In this example, client 110 may present the proof of authentication to each authentication consumer 102₁ through 102_{N}. Depending upon the implementation, each authentication consumer 102₁ through 102_{N} may receive the authentication assertion with the proof of authentication from client 110 or may use the proof of authentication to retrieve the authentication assertion from authentication server 106. Each authentication consumer 102₁ through 102_{N} makes a local entitlement decision based on the assurance score. While one authentication consumer 102₁ through 102_{N} may grant access to a specific process based on the assurance score, another one of the authentication consumers 102₁ through 102_{N} may deny access to a specific process based on the same assurance score.

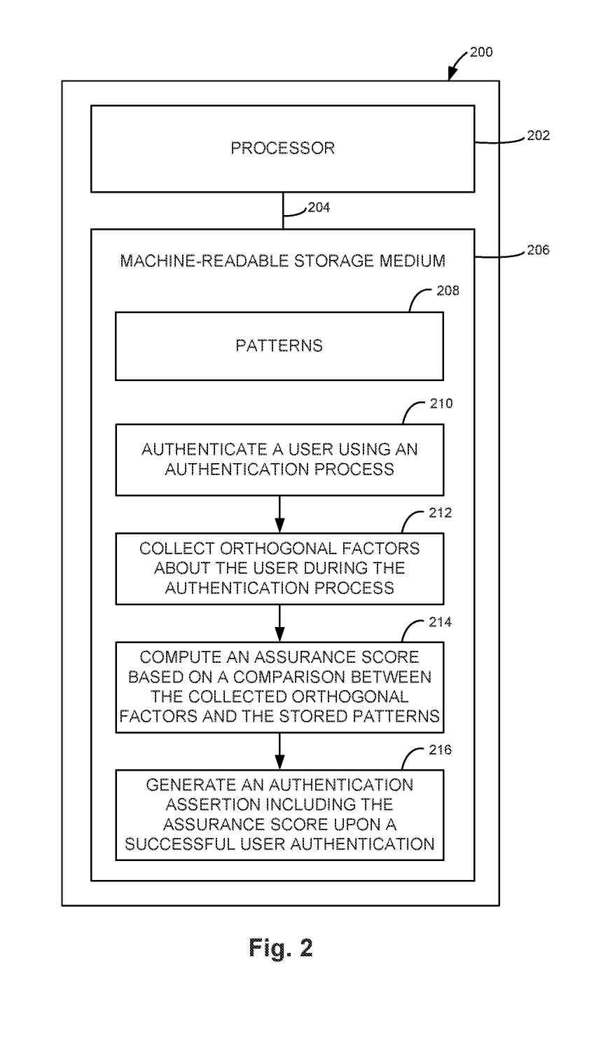

FIG. 2 is a block diagram illustrating one example of a processing system 200 for generating an authentication assertion including an assurance score based on orthogonal factors. System 200 includes a processor 202 and a machine-readable storage medium 206. Processor 202 is communicatively coupled to machine-readable storage medium 206 through a communication path 204. Although the following description refers to a single processor and a single machine-readable storage medium, the description may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 202 includes one or more central processing units (CPUs), microprocessors, and/or other suitable hardware devices for retrieval and execution of instructions stored in machine-readable storage medium 206. Machine-readable storage medium 206 may store data 208 including patterns. In one example, the stored patterns include patterns indicating fraud or distress. In another example, the stored patterns include at least one of stress patterns of the anatomy of users and behavior patterns of users.

Processor 202 may fetch, decode, and execute instructions 210-216 to generate an assurance score based on orthogonal factors. Processor 202 may fetch, decode, and execute instructions 210 to authenticate a user using an authentication process. Processor 202 may fetch, decode, and execute instructions 212 to collect orthogonal factors about the user during the authentication process. Processor 202 may fetch, decode, and execute instructions 214 to compute an assurance score based on a comparison between the collected orthogonal factors and the stored patterns. Processor 202 may fetch, decode, and execute instructions 216 to generate an authentication assertion including the assurance score upon a successful user authentication.

In one example, processor 202 may fetch, decode, and execute further instructions to provide the authentication assertion including the assurance score to an authentication consumer. The authentication consumer may then make a local entitlement decision based on the assurance score. In another example, processor 202 may fetch, decode, and execute further instructions to provide the authentication assertion including the assurance score to the user. The user may provide the authentication assertion including the assurance score to an authentication consumer. The authentication consumer may then make a local entitlement decision based on the assurance score.

As an alternative or in addition to retrieving and executing instructions, processor 202 may include one or more electronic circuits comprising a number of electronic components for performing the functionality of one or more of the instructions in machine-readable storage medium 206. With respect to the executable instruction representations (e.g., boxes) described and illustrated herein, it should be understood that part or all of the executable instructions and/or electronic circuits included within one box may, in alternate examples, be included in a different box illustrated in the figures or in a different box not shown.

Machine-readable storage medium 206 is a non-transitory storage medium and may be any suitable electronic, magnetic, optical, or other physical storage device that stores executable instructions. Thus, machine-readable storage medium 206 may be, for example, random access memory (RAM), an electrically-erasable programmable read-only memory (EEPROM), a storage drive, an optical disc, and the like. Machine-readable storage medium 206 may be disposed within system 200, as illustrated in FIG. 2. In this case, the executable instructions may be installed on system 200. Alternatively, machine-readable storage medium 206 may be a portable, external, or remote storage medium that allows system 200 to download the instructions from the portable/external/remote storage medium. In this case, the executable instructions may be part of an installation package.

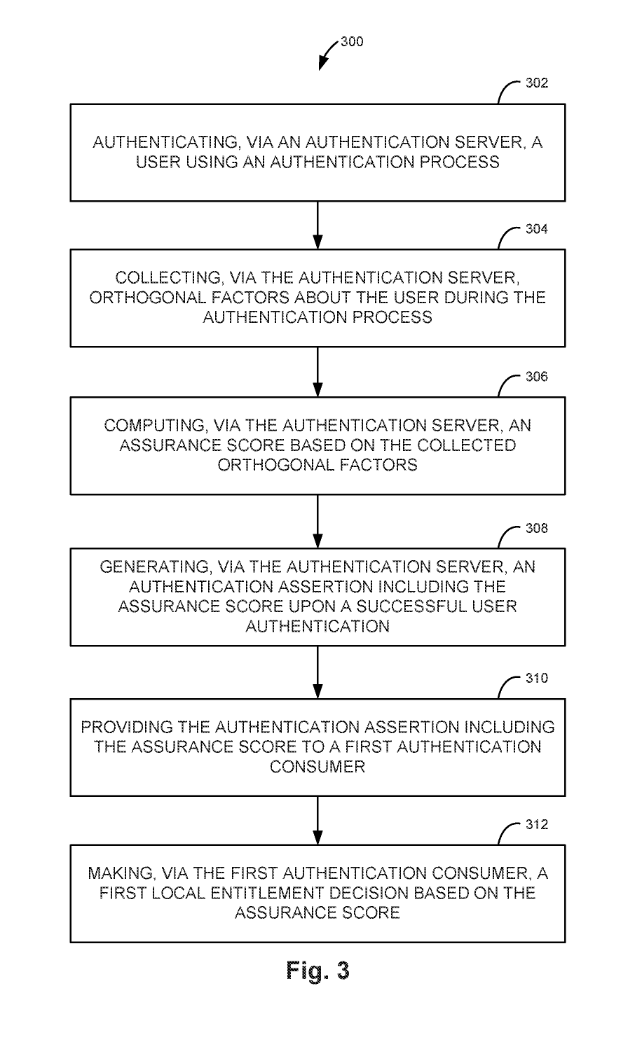

FIG. 3 is a flow diagram illustrating one example of a method 300 for generating and using authentication assertions including an assurance score based on orthogonal factors. At 302, method 300 includes authenticating, via an authentication server, a user using an authentication process. In one example, authenticating the user includes authenticating the user using a pass or fail authentication process.

At 304, method 300 includes collecting, via the authentication server, orthogonal factors about the user during the authentication process. In one example, collecting orthogonal factors about the user during the authentication process includes collecting at least one of (1) stress patterns in the user's voice, (2) stress patterns in the user's iris, (3) stress patterns based on the user's galvanic skin response and heart rate, (4) patterns in the user's body movement that vary from previously learned body movements, (5) patterns in the user's eye movement that vary from previously learned eye movements, (6) metadata from sensors that vary from previously learned metadata indicating the user's gender, age, or medical condition, and (7) the presence or absence of IoT enabled body implants of the user. In other examples, other suitable orthogonal factors about the user may be collected.

At 306, method 300 includes computing, via the authentication server, an assurance score based on the collected orthogonal factors. At 308, method 300 includes generating, via the authentication server, an authentication assertion including the assurance score upon a successful user authentication. At 310, method 300 includes providing the authentication assertion including the assurance score to a first authentication consumer. At 312, method 300 includes making, via the first authentication consumer, a first local entitlement decision based on the assurance score.

Method 300 may further include providing the authentication assertion including the assurance score to a second authentication consumer. In this example, method 300 also includes making, via the second authentication consumer, a second local entitlement decision different from the first local entitlement decision based on the assurance score. In another example, method 300 further includes enabling, via the first authentication consumer, a first process based on the first local entitlement decision. In this example, method 300 also includes disabling, via the first authentication consumer, a second process based on the first local entitlement decision.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A system comprising:
an authentication server to authenticate a user using an authentication process, collect environment specific attributes about the user during the authentication process, compute an assurance score based on the collected environment specific attributes, and generate an authentication assertion including the assurance score upon a successful user authentication; and
an authentication consumer to receive the authentication assertion including the assurance score and make a local entitlement decision based on the assurance score.

2. The system of claim 1, wherein the local entitlement decision allows the user to access at least one process of the authentication consumer and denies the user access to at least one other process of the authentication consumer.

3. The system of claim 1, wherein the authentication server stores the authentication assertion including the assurance score, and
wherein the authentication consumer retrieves the authentication assertion including the assurance score from the authentication server in response to receiving a request from the user.

4. The system of claim 1, wherein the authentication server provides the authentication assertion including the assurance score to the user, and
wherein the user provides the authentication assertion including the assurance score to the authentication consumer.

5. The system of claim 1, further comprising:
at least one sensor to sense at least one of physiological data of the user and behavioral data of the user to provide the environment specific attributes.

6. A system comprising:
a machine-readable storage medium storing instructions and patterns; and
a processor to execute the instructions to:
authenticate a user using an authentication process;
collect orthogonal factors about the user during the authentication process;
compute an assurance score based on a comparison between the collected orthogonal factors and the stored patterns; and
generate an authentication assertion including the assurance score upon a successful user authentication.

7. The system of claim 6, wherein the processor is to execute the instructions to provide the authentication assertion including the assurance score to an authentication consumer,
wherein the authentication consumer makes a local entitlement decision based on the assurance score.

8. The system of claim 6, wherein the processor is to execute the instructions to provide the authentication assertion including the assurance score to the user,
wherein the user provides the authentication assertion including the assurance score to an authentication consumer, and
wherein the authentication consumer makes a local entitlement decision based on the assurance score.

9. The system of claim 6, wherein the stored patterns comprise patterns indicating fraud or distress.

10. The system of claim 6, wherein the stored patterns comprise at least one of stress patterns of the anatomy of users and behavior patterns of users.

11. A method comprising:
authenticating, via an authentication server, a user using an authentication process;
collecting, via the authentication server, orthogonal factors about the user during the authentication process;
computing, via the authentication server, an assurance score based on the collected orthogonal factors;
generating, via the authentication server, an authentication assertion including the assurance score upon a successful user authentication;
providing the authentication assertion including the assurance score to a first authentication consumer; and
making, via the first authentication consumer, a first local entitlement decision based on the assurance score.

12. The method of claim 11, further comprising:
providing the authentication assertion including the assurance score to a second authentication consumer; and
making, via the second authentication consumer, a second local entitlement decision different from the first local entitlement decision based on the assurance score.

13. The method of claim 11, further comprising:
enabling, via the first authentication consumer, a first process based on the first local entitlement decision; and
disabling, via the first authentication consumer, a second process based on the first local entitlement decision.

14. The method of claim 11, wherein authenticating the user comprises authenticating the user using a pass or fail authentication process.

15. The method of claim 11, wherein collecting orthogonal factors about the user during the authentication process comprises collecting at least one of:
stress patterns in the user's voice;
stress patterns in the user's iris;
stress patterns based on the user's galvanic skin response and heart rate;
patterns in the user's body movement that vary from previously learned body movements;
patterns in the user's eye movement that vary from previously learned eye movements;
metadata from sensors that vary from previously learned metadata indicating the user's gender, age, or medical condition; and
the presence or absence of internet of things enabled body implants of the user.
